(19) United States
(12) Patent Application Publication
(10) Pub. No.: US 2010/0203219 A1
(43) Pub. Date: Aug. 12, 2010

(54) FRYING SHORTENING COMPOSITIONS HAVING IMPROVED FRYING PERFORMANCE

(75) Inventors: Lorin Roger Debonte, Fort Collins, CO (US); Daniel Scott Lampert, Anna, OH (US); Linsen Liu, Irvine, CA (US)

Correspondence Address: CARGILL, INCORPORATED, P.O. Box 5624, MINNEAPOLIS, MN, 55440-5624, US

(73) Assignee: CARGILL INCORPORATED, Wayzata, MN (US)

(21) Appl. No.: 12/670,837

(22) PCT Filed: Jul. 25, 2008
(86) PCT No.: PCT/US08/09023

§ 371 Date: Jan. 26, 2010

Related U.S. Application Data
(60) Provisional application No. 60/962,215, filed on Jul. 27, 2007.

(51) Int. Cl. A23D 9/00; A23L 1/01

(52) U.S. Cl. 426/606; 426/438

(57) ABSTRACT

Disclosed are frying shortening compositions that comprise liquid oil component comprising: (i) a first liquid oil comprising canola oil; and (ii) a second liquid oil selected from the group consisting of soybean oil, mid-oleic sunflower oil, corn oil, and combinations thereof; and (b) about 1-30 wt %, e.g., about 16-20 wt %, of a hard fat component comprising a hydrogenated vegetable oil, e.g., hydrogenated cottonseed oil. The fried foods are low in trans-fatty acids and saturated fatty acids and may be used to prepare fried food articles, e.g., doughnuts, having a high food-to-oil ratio.

### CROSS-REFERENCE TO RELATED APPLICATIONS

This application claims the benefit of U.S. Provisional Patent Application Ser. No. 60/962,215, filed Jul. 27, 2007, and entitled “Shortening Composition Having Improved Frying Performance”, the disclosure of which is incorporated herein by reference.

### FIELD

The present invention relates generally to frying shortening compositions and has particular utility in connection with frying foods. Some implementations of the invention provide fats low in trans-fatty acids that can produce fried foods meeting the US Food and Drug Administration labeling requirements for 0 g of trans-fatty acids per serving.

### BACKGROUND

Dietary consumption of foods high in trans-fatty acids or “trans fats” has been linked to increased serum cholesterol content. While some products containing no or low levels of trans fat have already been introduced, there are several factors that have limited the introduction of low or no trans fat alternatives into the marketplace. For example, replacements of trans fat must provide at least comparable characteristics of the final food product (e.g., flavor, texture, flakiness). Many of these highly desirable food characteristics are best achieved through the use of trans-fats or saturated fats. Because saturates are often associated with increased blood cholesterol levels, it is not in the best interests of consumers or the food industry to increase saturates as a means to replace trans fats.

The US Food and Drug Administration (FDA) now requires that labels for food products state the food's trans fat content. These labeling requirements state that a fat may be designated as having zero grams of trans fat per serving if a 14 g serving of the fat has no more than 0.5 grams of trans fat. The final trans fat content of a food product prepared using a fat, e.g., a fried food, will depend on the trans fat content of the fat used to prepare the food and the amount of oil incorporated in a serving of the food.

Some of the commonly used techniques to provide food products containing little or no trans-fat include interesterification of unhydrogenated oils with highly saturated base oils, the use of improved vegetable oils obtained by traditional plant breeding or biotechnology, the use of jelling or texture building agents, use of antioxidants to increase oil stability, blending of vegetable oils with partially hydrogenated fats, or a combination of any of the above.

Even if one fries food in a low trans fat shortening, the amount and nature of the shortening incorporated in the fried food product affect the organoleptic properties of the food. Hence, a low trans fat frying shortening suitable for frying French fries may not be suitable for frying doughnuts. In addition, the amount of oil absorbed by food during frying will affect the caloric content of the fried food and the yield or throughput of the frying operation, i.e., a food processor can fry more food in a given quantity of shortening if less of the fat is incorporated in the fried food.

### SUMMARY

The present invention relates generally to frying shortenings. Certain embodiments provide frying shortening compositions. Other embodiments provide methods for frying foods and fried foods having low amounts of undesirable fatty acids, e.g., trans-fatty acids and saturated fatty acids.

In one aspect, the invention provides frying shortening compositions. In some embodiments, the frying shortening compositions comprise: (a) about 70-99% weight (wt %), e.g., about 80-84 wt %, of a liquid oil component comprising: (i) a first liquid oil comprising canola oil; and (ii) a second liquid oil selected from the group consisting of soybean oil, mid-oleic sunflower oil, corn oil, and combinations thereof; and (b) about 1-30 wt %, e.g., about 16-20 wt %, of a hard fat component comprising a hydrogenated vegetable oil, e.g., hydrogenated cottonseed oil. In many embodiments, the shortening compositions are low in trans-fatty acids and low in saturated fatty acids.

Representative hard fats include hydrogenated cottonseed oil, cottonseed oil stearine, hydrogenated soybean oil, soybean oil stearine, hydrogenated palm oil, palm oil stearine, hydrogenated canola oil, and canola oil stearine. In many embodiments, hydrogenated cottonseed oil is preferred.

In some embodiments, the liquid oil component comprises both canola oil, preferably unhydrogenated, high-oleic canola oil, and soybean oil. In many embodiments, the weight ratio of canola oil to soybean oil (i.e., wt canola:wt soybean) ranges between about 40:1 and about 1:1. In one adaptation of the shortening, some or all of the soybean oil may be replaced by mid-oleic sunflower oil or corn oil. In another adaptation of the shortening, the liquid oil component comprises both a high-oleic, low-linolenic canola oil (HOLL) and a conventional canola oil, for example, in a ratio of 40:1 to about 1:1. The shortening compositions may include other additives, e.g., an antioxidant, commonly employed in the art.

In some embodiments, the frying shortening compositions comprise: (a) about 70-99 wt % of a liquid oil component comprising: (i) a first liquid oil comprising canola oil (e.g., a HOLL canola oil); and (ii) a second liquid oil comprising soybean oil; and (b) about 1-30 wt % of a hard fat component comprising a hydrogenated cottonseed oil. In some embodiments, the shortening composition comprises about 40-63 wt % canola oil; about 20-42 wt % soybean oil; and about 16-20 wt % hydrogenated cottonseed oil. In one preferred embodiment, the shortening composition comprises about 41 wt % canola oil; about 41 wt % soybean oil; and about 18 wt % hydrogenated cottonseed oil. In another preferred embodiment, the shortening composition comprises about 61.5 wt % canola oil; about 20.5 wt % soybean oil; and about 18 wt % hydrogenated cottonseed oil.

In another aspect, the invention provides methods of preparing fried food products that includes frying a food article, e.g., a doughnut, in such a frying shortening composition. Other embodiments of the invention contemplate fried foods, e.g., doughnuts, made by frying in such a frying shortening composition. Desirably, these fried foods meet FDA requirements for zero-trans labeling, i.e., have less than 0.5 g of trans fat per serving of the fried food.

Advantageously, in many embodiments, the frying shortening compositions of the invention may be used to prepare fried food compositions that have a high food-to-oil ratio. A high food-to-oil ratio is desirable since it indicates that less of the shortening composition has been retained in the fried food article causing a reduction in fat calories and improvement in the fried food's nutritional profile. Additionally, high food-to-oil ratio also reduces consumption of oil providing a higher yield of fried food product for a given amount of oil consumed. In some embodiments, fried food articles of the invention have a food-to-oil ratio that is about 5% higher or greater than a fried food article prepared with a shortening composition comprising 83 wt % HOLL canola oil and 17 wt % hydrogenated cottonseed oil. In some embodiments, the fried food articles of the invention have a food-to-oil ratio that is about 5% higher or greater than a fried food article prepared with a shortening composition comprising modified palm and cottonseed oil. In yet other embodiments, the fried food articles of the invention have a food-to-oil ratio that is about 5% higher or greater than a fried food article prepared with a shortening composition comprising partially hydrogenated soybean oil.

### DETAILED DESCRIPTION

The present invention provides shortening compositions that, in certain embodiments, are low in trans-fatty acids and saturated fatty acids, and have improved frying attributes when compared, for example, to commercially available vegetable shortening.

### Characterizing Shortenings:

Commonly owned PCT Application No. PCT/US2005/023359 (published as International Publication No. WO 2006/014322) also provides useful background on low-trans shortenings.

Double bonds in fatty acids in crude vegetable oils tend to be in the “cis” configuration. Hydrogenation of such oils results in the formation of fatty acids having double bonds in the “trans” configuration. Saturated fatty acids are fatty acids that lack a carbon-to-carbon double bond, and include myristic (C14:0), palmitic (C16:0), stearic (C18:0), arachidic (C20:0), and lignoceric (C24:0) acids.

Trans-fatty acids include any trans isomer of a C14 through C24 fatty acid, and can be detected using, for example, a method described by Madison, et al. (1982, Amer. Oil Chem. Soc., 59:178-81). Free fatty acids are fatty acids that are not esterified. The amount of free fatty acids can be determined, for example, using American Oil Chemists' Society (AOCS) method Ca 5a-40. Fatty acid composition can be determined, for example, using AOCS method Ce 1e-91.

Iodine value (IV) is a measure of the unsaturated linkages in a fat and is expressed by the number of grams of iodine equivalent to halogen adsorbed by a 100 gram sample of fat. IV is a laboratory test; commercial fats do not contain iodine. IV can be measured, for example, using AOCS Official Method Cd 1-25, also known as the Wijs method. IV also can be determined from the fatty acid composition using AOCS Method Cd 1c-85.

Peroxide value (PV) is a measurement of oxidized fatty acids, which is the primary oxidation product in oils, relative to total fatty acids. PV generally is expressed as milli-equivalents of peroxide-oxygen combined per kilogram of fat (meq/kg). PV can be determined, for example, using AOCS method Cd 8b-90.

Oxidative stability relates to how easily components of an oil oxidize, which creates off-flavors in the oil. The Oil Stability Index (OSI) method is used to determine oils' and fats' resistance to rancidity. OSI results are expressed in hours at 110° C. OSI can be determined using an Oxidative Stability Instrument (Onion/Archer Daniels Midland, Decatur, Ill.) in accordance with AOCS method Cd 12b-92, for example. The Active Oxygen Method (AOM) is another rancidity test in which the fat to be tested is held at an elevated temperature (e.g., 98° C.) and through which air is bubbled at a specified rate. A peroxide value is determined at intervals. The endpoint is reported in hours required to reach a peroxide value of 100 meq/kg. AOM hours can be determined, for example, using AOCS method Cd 12-57.

The Schaal oven method of accelerated aging is used to measure the oxidative and flavor stability of a fat or a fat-containing food product. The Schaal oven method involves examining samples of an oil or food product held at an elevated temperature at regular intervals. Sometimes the oil or food product is held in the dark. Results are reported as the time elapsing until a rancid odor or flavor is detected. Under certain Schaal oven conditions, one day is approximately equivalent to one-month storage in the dark at ambient temperature.

Solid fat index (SFI) is an empirical measurement of the solid fat content of a sample over a deemed temperature scale. SFI is a dilatometric procedure relying on volumetric changes occurring during melting and crystallization. See, for example, AOCS Official Method Cd 10-57 (re'vd 1989). Solid fat content (SFC) is the actual percent of solid fat at standard temperature points. SFC is typically measured by pulsed nuclear magnetic resonance (PNMR). See, for example, AOCS Official Method Cd 16b 93. See, also, Bailey's Industrial Oil & Food Products, 5ih Ed., John Wiley & Sons, Inc., Vol. 4 (1996) for additional information on SFI and SFC.

The Mettler Drop Point (MDP) is the temperature at which a solid fat becomes fluid to flow. The MDP can be determined, for example, using AOCS Official Method Cc 18-80 (re'vd 1989).

The color of an oil can be determined using, for example, AOCS method Cc 13b 43, and using, for example, an American Oil Tintometer (e.g., Model AF715, The Tintometer LTD., Salisbury, England). Color of oils is evaluated using a series of red and yellow standardized glass slides as references. Oil color, therefore, is reported in values of yellow and red.

Fry stability relates to the resistance to degeneration of the oil during frying.

“Fry life” is the time it takes for the flavor of a product fried in an oil to degrade to a set sensory score.

Shelf-life stability of an oil or a food product made using an oil can be determined by analyzing food samples made with or cooked in the oil, and then packaged and stored in an oven at an elevated temperature to accelerate aging. “Shelf-life” is the time it takes for a food product to degrade to a set sensory score.

Flavor stability is the time it takes for the flavor of an oil to degrade, typically to a set sensory score.

The plasticity or hardness (e.g., the rheological qualities) of a shortening can be evaluated using a cone penetrometer. For this assay, a cone with a particular angle (e.g., a 45° angle) generally is used. The depth of penetration into the sample and the penetration time can be measured. See, for example, Humphrey et al., 2003, J. Amer. Oil Chemists' Soc., 80:1175-1182, American Society for Testing and Materials (A.S.T.M.) Methods D-217, D-5 and D-937; and American Oil Chemist Society, Official Methods and Recommended Practices, 4th Ed., 1996, AOCS Cc 16-60.

### Shortening Compositions:

The term “shortening” refers to an oil (i.e., a fat product) that is plastic at ambient temperature (e.g., room temperature). See, e.g., Campbell et al., Food Fats and Oils, 8th Ed., Institute of Shortening and Edible Oils, Washington D.C.; Orthoefer, “Performance of trans-free vegetable oils in shortenings and deep-fat frying”, Lipid Technology, Vol. 17, No. 5, pages 101-106, May 2005. Shortening in one embodiment of the invention is a combination of a hard fat component (e.g., hydrogenated cottonseed oil, cottonseed oil stearine, hydrogenated soybean oil, soybean oil stearine, hydrogenated palm oil, palm oil stearine, hydrogenated canola oil, or canola oil stearine) and a liquid oil component. In many embodiments, the liquid oil comprises both canola oil and soybean oil. This shortening may possess very little, if any, trans-fatty acids; such shortenings desirably include less than 0.5 g of trans fat per 14 g of shortening, or no more than about 3.5 wt % trans fat, or less than about 2 wt %. Embodiments of the shortening also typically comprise about 25% saturated fatty acids or less, making the total of trans-fatty acids and saturated fatty acids (trans+sats) about 30 wt % or less. These shortenings are especially suitable for use in frying foods.

Liquid Oil: In many embodiments, the liquid oil component of the shortenings of the invention comprises canola oil and soybean oil, and may optionally include one or more other liquid oils. Although hydrogenated liquid oil can be used, liquid oil that has not been hydrogenated and has little or no trans-fatty acids (e.g., contains less than 2 wt % or less than 1 wt % trans-fatty acids (e.g., 0 wt %, 0.1 wt % to 2 wt %, 0.2 wt % to 1.8 wt %, 0.4 wt % to 1.8 wt %, 0.6 wt % to 1.0 wt %, 0.8 wt % to 1.6 wt %, 1.0 wt % to 1.8 wt %, or 1.4 wt % to 1.9 wt %)) is preferred. A liquid oil suitable for use in the invention generally has less than about 8.5 wt % α-linolenic acid (e.g., about 0.1 wt % to about 7 wt %, about 0.5 wt % to about 7 wt %, about 1 wt % to about 5 wt %, or about 2 wt % to about 6 wt %); between about 7 wt % and about 56 wt % of polyunsaturated fatty acids (e.g., about 10 wt % to about 50 wt %, about 8 wt % to about 30 wt %, about 15 wt % to about 45 wt %, or about 20 wt % to about 40 wt %); and/or less than about 15 wt % saturated fatty acids (e.g., less than about 12 wt %, 10 wt %, 8 wt %, 5 wt %, 3 wt %, or 1 wt %).

Non-limiting examples of suitable liquid canola oils that can be used in a shortening of the invention include Clear Valley 65® (CV 65; Cargill, Wayzata, Minn.), Clear Valley 75® (CV 75; Cargill, Wayzata, Minn.), and Clear Valley 85® (CV 85; Cargill, Wayzata, Minn.). CV 65, CV 75, and CV 85 are refined, bleached and deodorized oils produced from seeds of high oleic acid, low α-linolenic acid (“HOLL”) Brassica napus plant lines. Other low-linolenic canola oils are also expected to be useful in the present shortenings. The table below shows the typical characteristics of CV 65, CV 75, CV 85, and a representative high oleic sunflower oil.

Characteristics of CV 65 ®, CV 75 ®, CV 85 ® and
a High Oleic Sunflower Oil

| | | | | High Oleic |
|---|---|---|---|---|
| | CV 65 ® | CV 75 ® | CV 85 ® | Sunflower Oil |
| Oleic Acid (%) | 60-70 | 73-80 | 78-85 | 78-86 |
| Linoleic Acid (%) | 15-25 | 8-15 | 3-8 | 6-12 |
| Erucic Acid (%) | <1 | <1 | <1 | ND |
| α-Linoleic Acid (%) | 2-5 | 2-5 | 1.5-3.5 | <0.5 |
| Total Sats (%) | 6-7.5 | 6-7.5 | 5-7 | 8-10 |
| Trans-fatty Acids | 0.5-1.1 | 0.5-1.1 | 0.5-1.1 | <1.0 |
| (%) | | | | |
| IV | <115 | <95 | <89 | <87 |
| AOM hours | ~30 | ~37 | ~65 | >40 |

* ND, not detectable

The α-linolenic acid content in the CV 65® oil typically is from about 2.5% to about 4.5% (e.g., about 2.6% to about 4%, about 3% to about 3.8%, or about 3.5% to about 4.4%). CV 65® oil has an oleic acid content of about 60% to about 72% by weight (e.g., about 62% to about 70%, about 64% to about 68%, or about 65% to about 67%), a linoleic acid content of about 15% to about 25% by weight (e.g., about 16% to about 23%, about 18% to about 20%, or about 20% to about 24%), and an erucic acid content of less than about 1% by weight (e.g., less than about 1.0, or 0.5%). The CV 65®, CV 75®, and CV 85® oils have a trans-fatty acid content of about 0.5% to about 1.1% (e.g., about 0.6% to about 1.0%, about 0.7% to about 0.9%, or about 0.9% to about 1.1%). CV 65® oil generally has an iodine value of less than about 115 (e.g., less than about 110, 105, or 100) and an AOM value of about 30 hours (e.g., about 28, 32, or 35 hours); CV 75® oil generally has an iodine value of less than about 95 (e.g., less than about 90, 85, or 80) and an AOM value of about 37 hours (e.g., about 35, 38, or 40 hours); CV 85® oil generally has an iodine value of less than about 89 (e.g., less than about 85, 80, or 75) and an AOM value of about 80 hours (e.g., about 75, 78, or 82 hours).

Suitable liquid soybean oils include, but are not limited to, conventional soy salad oil, low-linolenic soybean oil, and mid-oleic, low-linolenic soybean oils. Low-linolenic soybean oils produced from Monsanto's Vistive seed are commercially available from Cargill, Incorporated (Wayzata, Minn.) and Bunge North America (St. Louis, Mo.). Mid-oleic, low-linolenic soybean oils available from Iowa Natural (Clive, Iowa) are expected to work well.

The liquid oil component of the shortening may also optionally include liquid oils besides canola oil and soybean oil. For example, sunflower oil, e.g., mid-oleic sunflower oil commercially available from Cargill, Incorporated (Wayzata, Minn.) under the NuSun® mark, is expected to work well. In one particular embodiment, the soybean oil in the liquid oil component may be partially or completely replaced by sunflower oil, e.g., mid-oleic sunflower oil, corn oil, or a combination thereof. In this instance, the liquid component may comprise canola oil and a second liquid fraction in a ratio of about 40:1 to about 1:1 and the second liquid fraction may comprise as much as 100% soybean oil, as much as 100% sunflower oil and/or corn oil, or any ratio in between. The second fraction may also include other liquid oils, preferably vegetable oils.

In one modified embodiment, the canola oil comprises a HOLL canola oil and the soybean oil in the liquid oil component may be partially or completely replaced by conventional canola oil, sunflower oil, and/or corn oil. For example, the liquid oil component may comprise HOLL canola oil and conventional canola oil in a ratio of about 40:1 to about 1:1. Although higher inclusion rates of conventional canola oil may be employed, fry life may begin to suffer as a consequence.

Liquid oils used in shortenings of the invention are generally refined, bleached and deodorized (RBD) oils. Refining refers to removing most if not all free fatty acids and other impurities such as phosphatides or protein substances from a crude oil. One common method of refining is done by treating an oil with a strong base, followed by extensive washings with water. Bleaching refers to a process that removes natural pigments (carotenoids, chlorophylls, and xanthophylls) and other impurities such as metal cations (e.g., Fe, Cu and Zn). Bleaching can be done by absorbing such pigments and/or cations on a natural bleaching earth or clay, which is usually added to an oil under vacuum and high temperature. Deodorizing refers to the removal of relatively volatile trace components (e.g., ketones, aldehydes, alcohols) from an oil that contribute to flavor, odor, and color. Deodorizing is usually done by injecting steam into an oil heated to high temperatures (e.g., about 470° F. to about 510° F.) under high vacuum (e.g., <5 mm Hg).

Hard Fat: A hard fat used in a shortening described herein contains few or no double bonds in fatty acyl moieties of the fat. In some embodiments, a fat having unsaturated bonds can be hydrogenated to form a hard fat suitable for use as described herein. Hydrogenating the oil to an Iodine Value (IV) of no more than about 5 (e.g., 3 or less) will help keep the trans fat content of the final shortening low because fewer double bonds remain. Alternately, a hard fat used in a frying shortening as described herein need only be hydrogenated to an IV of about 10 (e.g., about 9, 11, or 12).

The hard fat used in a shortening of the invention also can be a stearine fraction. A stearine fraction primarily consists of stearic acid, a saturated 18-carbon fatty acid, and palmitic acid, a saturated 16-carbon fatty acid.

Fractionation methods using differences in melting point or volatility, for example, can be used to obtain a stearine fraction from, for example, cottonseed oil, soybean oil, palm oil, and canola oil. See, for example, Bailey's Industrial Oil & Fat Products, 5^{th} Ed., Hui, Ed., John Wiley & Sons, Inc., 1996.

Additives: Common additives can be added to the shortening of the present invention such as stabilizers, flavoring agents, emulsifiers, anti-spattering agents, colorants, or antioxidants. See, for example, Campbell et al., Food Fats and Oils, 8^{th} Ed., Institute of Shortening and Edible Oils, Washington, D.C. for information on a variety of additives.

Blending of the hard fat and the liquid oil component commonly requires melting of the hard fat, which can be done prior to, during, or after addition of the liquid oil. Hard fats suitable for use in the invention typically have a MDP of about 136° F. to about 160° F. The components of the liquid oil can be pre-blended before blending with the hard fat or all of the fats can be blended in a single operation. Antioxidants or other additives can be added to the blend. For frying applications, the blended shortening can be delivered in a heated container, e.g., a heated tank car, as a molten liquid.

In smaller quantities and for other shortening applications, the shortening may be processed into a stable solid. For example, the warm blended shortening can be cooled in one or more scraped-surface heat exchangers, which can utilize, for example, glycol, brine, freon, or liquid ammonia as a means to cool the heat exchanger(s). The blend is pumped through the heat exchanger(s) and sufficient heat is removed to cause crystallization (solidification) of the fat. The heat exchange process, commonly referred to as “votation,” may be conducted using a Votator-brand heat exchanger (Waukesha Cherry-Burrell, Delevan, Wis.), for example. The solidified product exiting the votator is a homogeneous composition with homogeneous consistency. Votation followed by agitation in, for example, a “pie” unit, facilitates the formation of crystal structure such that the resulting shortening is smooth in appearance and firm in consistency. By varying the conditions of the votation process, products for different applications (e.g., baking, creaming, or frying) can be produced.

The machine process of controlling crystal formation crystals and making a semi-solid shortening (i.e., semi-solid at ambient temperatures), including the step of votation, is known as plasticizing. Nitrogen can be introduced into the blend at the time of entry into the scraped surface heat exchanger. The nitrogen provides for improved creaminess and a white appearance of the final shortening product. Upon exiting of the blend from the votator, the crystals begin to form a matrix very rapidly and a firm shortening is formed. The liquid oil is interspersed with the crystals of the hard fat, forming a uniform semi-solid shortening. The shortening can be tempered, for example, at 65° F. to 90° F. for 24 to 96 hours to allow the crystal structure to develop and stabilize.

Preparation of Fried Foods: Frying shortening compositions in accordance with embodiments of the invention can be used in a wide variety of applications. For example, they may be incorporated into doughs or mixes to make food products such as doughnuts, pizzas, crusts (e.g., pie crusts), cookies, biscuits, pastries (e.g., toaster pastries), bread, or the cream in a cream-filled food product (e.g., Oreo cookies). Since the shortenings described herein contain little to no trans-fatty acids, food products made with such shortenings contain reduced levels of or no trans-fatty acids per serving as compared to the same food product made using many other known shortenings.

Certain shortenings in accordance with embodiments of the invention have shown particular promise as a frying shortening. A food product also or alternatively can be cooked (e.g., fried) in a shortening described herein. Certain embodiments of the invention have shown surprisingly superior performance in this context. The normal temperature range for frying with such a shortening is 325° F. to 375° F. Most foods cook rapidly in this range and develop a golden color, crisp texture, and good flavor. Frying time is longer at lower temperatures, and results in lighter color, less flavor, and increased oil absorption; higher temperatures allow shorter frying times and generally produce thinner, crispier crusts and less oil absorption.

A food product and the effect of a particular ingredient or process also can be evaluated by examining the sensory attributes of a food product. Sensory attributes include, for example, appearance, color, texture, moistness, and taste. Sensory attributes of food products are usually determined by a sensory panel, which may comprise trained panelists or a selection of likely consumers without formal training. A sensory panel refers to those individuals involved in the sensory evaluation of the edible food product. A panel can provide qualitative and quantitative scores for the sensory evaluation.

Advantageously, in many embodiments, the frying shortening compositions of the invention may be used to prepare fried food compositions that have a high food-to-oil ratio. A high food-to-oil ratio is desirable since it indicates that less of the shortening composition has been retained in the fried food article causing a reduction in fat calories and improvement in the fried food's nutritional profile. Additionally, high food-to-oil ratio reduces consumption of oil, providing a higher yield of fried food product for a given amount of oil consumed. In some embodiments, fried food articles of the invention have a food-to-oil ratio that is about 5% higher or greater than a fried food article prepared with a shortening composition comprising 83 wt % HOLL canola oil and 17 wt % hydrogenated cottonseed oil. In some embodiments, the fried food articles of the invention have a food-to-oil ratio that is about 5% higher or greater than a fried food article prepared with a shortening composition comprising modified palm and cottonseed oil. In yet other embodiments, the fried food articles of the invention have a food-to-oil ratio that is about 5% higher or greater than a fried food article prepared with a shortening composition comprising partially hydrogenated soybean oil.

### EXAMPLES

Aspects of select compositions and methods in accordance with the invention are illustrated in the following examples:

### Experiment 1

Frying doughnuts present some interesting challenges. As a general rule, an oil that is liquid a room temperature will not make a good frying oil for doughnuts. Though doughnuts might fry well in such liquid oils, the fried doughnuts typically are soft or soggy when they cool down. The oil in the doughnuts will also tend to leak out, leaving a coating of grease on their serving trays or cardboard containers. If a doughnut fried in liquid oil is coated with sugar or another coating, e.g., a chocolate glaze, the liquid fat may soak into the coating or limit the bonding of the coating to the surface of the doughnut. The resultant doughnuts are unattractive and generally perceived as undesirable.

To avoid these problems, most doughnuts are typically fried in partially hydrogenated vegetable shortening or the like. The partial hydrogenation makes the oil at least semi-solid at room temperature. Unfortunately, the partial hydrogenation significantly increases the trans fat content of the oil, typically resulting in several grams of trans fat in a single 14 g serving of the oil. This often produces a doughnut with more than 0.5 g of trans fat per serving. The food manufacturer typically cannot label such a doughnut as “trans fat-free” or as having 0 g of trans fat per serving. Some of the shortenings described above provide a low-trans or even “trans fat-free” shortening that produce excellent doughnuts.

In a first doughnut study, twenty dozen doughnuts were fried in each of three shortenings each day for 15 days. One shortening was DDA ZGTF Doughnut Fry Shortening, a frying shortening comprising modified palm and cottonseed oils available from Dawn Distributors Advantage of Jackson, Mich.; another was ELITE VFD doughnut frying shortening, a partially hydrogenated soybean oil (5 g of trans fat per serving) sold by Bunge North America, St. Louis, Mo.; and the third (identified in the tables below as S-25) was a shortening in accordance with embodiments of the invention and comprising about 61.5 wt % CV 65 HOLL canola oil, about 20.5 wt % non-hydrogenated soybean oil (aka “soy salad oil”), and about 18 wt % STABLE FLAKE® C, a hard flake (IV of 5 max) of hydrogenated cottonseed oil sold by Cargill, Incorporated, Wayzata, Minn.

The dough was a commercially purchased leavened uncooked dough (Giant Market, Pennsylvania) formed into doughnuts. The shortenings were preheated in separate deep fat fryers for about 60 minutes to a temperature of about 350° F. The doughnuts were cooked by dropping a dozen raw doughnuts in the fryer at a time, cooking on the underside for about 45 seconds, then flipping to cook the other side for another 45 seconds. The fried doughnuts were then removed from the fryer, allowed to drain, placed on a screen, and coated with a sugar glaze. Each day, a make-up quantity of oil was added to each fryer as necessary to maintain comparable oil volume in the fryer.

Doughnuts and used oil samples were collected on days 1, 5, 10, and 15 of the test for analysis. A sensory panel of 75-100 panelists evaluated three doughnuts, one being fried in each of the three shortenings, on each of the even days of the test. The panelists rated each doughnut on 6 sensory characteristics on a 7-point scale and selected which doughnut they preferred overall. In particular, the panelists rated appearance (1=dislike very much, 7=like very much), color (1=much too light, 7=much too dark), moisture content (1=too dry and crumbly, 4=just about right, and 7=too soggy/sticky), texture (1=dislike very much, 7=like very much), taste (1=dislike very much, 7=like very much), and overall liking (1=dislike very much, 7=like very much). The results of this sensory analysis are show in Tables 1-7.

TABLE 1
Appearance

| | DDA | Bunge VFD | S-25 |
|---|---|---|---|
| Day 2 | 4.78 | 5.16 | 5.27 |
| Day 4 | 5.04 | 5.51 | 5.28 |
| Day 6 | 5.29 | 5.58 | 5.49 |
| Day 8 | 4.91 | 5.11 | 5.16 |
| Day 10 | 4.83 | 5.06 | 5.52 |
| Day 12 | 5.03 | 5.02 | 5.42 |
| Day 14 | 5.13 | 5.26 | 5.45 |
| Average for | 5.04 | 5.26 | 5.39 |
| Session | | | |

TABLE 2
Color

| | DDA | Bunge VFD | S-25 |
|---|---|---|---|
| Day 2 | 3.47 | 4.15 | 4.01 |
| Day 4 | 3.95 | 3.89 | 3.91 |
| Day 6 | 3.63 | 4.06 | 4.06 |
| Day 8 | 4.14 | 3.94 | 4.45 |
| Day 10 | 4.13 | 3.87 | 4.47 |
| Day 12 | 3.68 | 4.1 | 3.86 |
| Day 14 | 3.84 | 3.78 | 4.15 |
| Average for | 3.83 | 3.97 | 4.13 |
| Session | | | |

TABLE 3
Moisture Content

| | DDA | Bunge VFD | S-25 |
|---|---|---|---|
| Day 2 | 3.57 | 3.98 | 3.91 |
| Day 4 | 3.8 | 3.94 | 3.83 |
| Day 6 | 3.73 | 3.94 | 3.84 |
| Day 8 | 3.62 | 3.82 | 3.8 |
| Day 10 | 3.71 | 3.88 | 3.73 |
| Day 12 | 3.88 | 3.72 | 4.03 |
| Day 14 | 3.61 | 3.89 | 3.99 |
| Average for | 3.70 | 3.88 | 3.88 |
| Session | | | |

TABLE 4
Texture

| | DDA | Bunge VFD | S-25 |
|---|---|---|---|
| Day 2 | 4.57 | 5.07 | 5.1 |
| Day 4 | 4.88 | 5.3 | 5.36 |
| Day 6 | 4.95 | 5.18 | 5.14 |
| Day 8 | 4.72 | 4.79 | 4.87 |
| Day 10 | 4.84 | 5.12 | 4.94 |
| Day 12 | 4.98 | 4.89 | 5.18 |
| Day 14 | 4.77 | 4.88 | 5.32 |
| Average for | 4.82 | 5.03 | 5.13 |
| Session | | | |

TABLE 5
Taste

| | DDA | Bunge VFD | S-25 |
|---|---|---|---|
| Day 2 | 4.64 | 5.35 | 5.04 |
| Day 4 | 4.89 | 5.26 | 5.09 |
| Day 6 | 5.16 | 5.38 | 4.99 |
| Day 8 | 4.93 | 5.13 | 5 |
| Day 10 | 4.93 | 5.46 | 4.98 |
| Day 12 | 5.16 | 5.21 | 5.4 |
| Day 14 | 4.93 | 5.15 | 5.28 |
| Average for | 4.95 | 5.28 | 5.11 |
| Session | | | |

TABLE 6
Overall Liking

| | DDA | Bunge VFD | S-25 |
|---|---|---|---|
| Day 2 | 4.46 | 5.11 | 5.16 |
| Day 4 | 4.75 | 5.09 | 5.09 |
| Day 6 | 5.11 | 5.47 | 5.02 |
| Day 8 | 4.62 | 5.08 | 4.84 |
| Day 10 | 4.93 | 5.4 | 4.93 |
| Day 12 | 5 | 5.17 | 5.14 |
| Day 14 | 4.95 | 5.16 | 5.26 |
| Average for | 4.83 | 5.21 | 5.06 |
| Session | | | |

TABLE 7
Which Sample Do You Prefer?

| | DDA | Bunge VFD | S-25 | No Preference |
|---|---|---|---|---|
| Day 2 | 16 | 24 | 37 | 4 |
| Day 4 | 20 | 28 | 27 | 6 |
| Day 6 | 24 | 36 | 22 | 11 |
| Day 8 | 30 | 35 | 33 | 6 |
| Day 10 | 23 | 33 | 30 | 3 |
| Day 12 | 25 | 28 | 37 | 9 |
| Day 14 | 24 | 21 | 41 | 8 |
| Average | 23.14 | 29.29 | 32.43 | 6.71 |
| for | | | | |
| Session | | | | |

Hence, the sensory analysis demonstrates that doughnuts fried in the S-25 shortening of the invention consistently rated higher in appearance, color, and texture. Although the average moisture, taste, and overall liking ratings were on a par with the other two shortenings, the S-25 shortening generally outperformed the other two shortenings in the later days of the testing, suggesting superior fry life and stability.

Initially, 25.2 kg of each shortening was added to its respective fryer. As noted above, a make-up quantity of shortening was added daily to replace oil that had been consumed. The total quantify of make-up shortening added to the fryer over the course of the 15 days was 20.448 kg of the DDA shortening, 19.920 kg of the VFD shortening, and only 18.960 kg of the S-25 oil. Though 3600 doughnuts (20 doz per day×15 days) were fried in each shortening, the frying consumed about 1-1.5 kg more of the other shortenings than was necessary to fry doughnuts in the S-25 oil. This consumption may be stated as a food-to-oil ratio, in which the weight of the doughnuts fried (3600 doughnuts at 47.5 g each, or 171 kilos total) is divided by the amount of make-up oil consumed. Table 8 highlights the food-to-oil ratios for the 3 shortenings over the life of the test:

TABLE 8
Food-To-Oil Ratio

| DDA | Bunge VFD | S-25 |
|---|---|---|
| 8.36 | 8.58 | 9.02 |

Surprisingly, the S-25 oil had a food-to-oil ratio more than 5% higher than that for the Bunge VFD shortening and almost 8% higher than that for the DDA shortening. This substantial yield improvement is important in two respects. First, producing the same fried food using less oil makes the S-25 oil more attractive economically. Second, the doughnuts absorbed less of the S-25 oil during frying, meaning that they picked up fewer fat calories as a result of frying. A 5-8% reduction in fat content represents a significant improvement of the fried food's nutritional profile.

### Experiment 2

A similar doughnut study was conducted using a different set of shortenings—the S-25 composition described above, an S-0 composition that included about 83 wt % CV 65 and about 17 wt % STABLE FLAKE® C, and an S-50 composition that included about 41 wt % CV 65, about 41 wt % non-hydrogenated soybean oil, and about 18 wt % STABLE FLAKE® C. The doughnuts were prepared in much the same fashion described in Example 1, except that on day 10 of this 10-day test the S-50 oil temperature was increased from 350° F. to 360° F.; the two other shortenings were maintained at 350° F. The sensory evaluation was conducted on the first 5 days of the test and the total oil consumption was measured at the end. The sensory data is shown in Tables 9-15 and the food-to-oil ratios are shown in Table 16.

TABLE 9
Appearance

| | S-0 | S-25 | S-50 |
|---|---|---|---|
| Day 1 | 5.58 | 5.87 | 5.54 |
| Day 2 | 5.3 | 5.29 | 5.24 |
| Day 3 | 5.27 | 5.55 | 5.19 |
| Day 4 | 5.39 | 5.64 | 4.93 |
| Day 5 | 5.54 | 5.41 | 5.53 |
| Average for | 5.375 | 5.4725 | 5.2225 |
| Session | | | |

TABLE 10
Color

| | S-0 | S-25 | S-50 |
|---|---|---|---|
| Day 1 | 4.19 | 4.12 | 3.91 |
| Day 2 | 4.01 | 4.08 | 4.29 |
| Day 3 | 4.03 | 4.2 | 3.97 |
| Day 4 | 3.88 | 4.08 | 4.33 |
| Day 5 | 3.93 | 3.72 | 4.18 |
| Average for | 4.008 | 4.04 | 4.136 |
| Session | | | |

TABLE 11
Moisture Content

| | S-0 | S-25 | S-50 |
|---|---|---|---|
| Day 1 | 3.81 | 3.95 | 3.79 |
| Day 2 | 3.92 | 3.99 | 3.61 |
| Day 3 | 3.93 | 3.93 | 3.71 |
| Day 4 | 3.97 | 3.91 | 3.62 |
| Day 5 | 3.86 | 3.99 | 3.84 |
| Average for | 3.898 | 3.954 | 3.714 |
| Session | | | |

TABLE 12
Texture

| | S-0 | S-25 | S-50 |
|---|---|---|---|
| Day 1 | 5.24 | 5.51 | 5.23 |
| Day 2 | 5.36 | 5.16 | 4.92 |
| Day 3 | 5.24 | 5.4 | 4.77 |
| Day 4 | 5.22 | 5.54 | 4.67 |
| Day 5 | 5.32 | 5.43 | 5.05 |
| Average for | 5.276 | 5.408 | 4.928 |
| Session | | | |

TABLE 13
Taste

| | S-0 | S-25 | S-50 |
|---|---|---|---|
| Day 1 | 5.53 | 5.67 | 5.32 |
| Day 2 | 5.33 | 5.38 | 4.72 |
| Day 3 | 5.39 | 5.33 | 4.68 |
| Day 4 | 5.36 | 5.72 | 4.93 |
| Day 5 | 5.57 | 5.61 | 5.17 |
| Average for | 5.436 | 5.542 | 4.964 |
| Session | | | |

TABLE 14
Overall Liking

| | S-0 | S-25 | S-50 |
|---|---|---|---|
| Day 1 | 5.22 | 5.64 | 5.12 |
| Day 2 | 5.38 | 5.34 | 4.76 |
| Day 3 | 5.21 | 5.32 | 4.68 |
| Day 4 | 5.46 | 5.7 | 4.75 |
| Day 5 | 5.29 | 5.32 | 5.03 |
| Average for | 5.312 | 5.464 | 4.868 |
| Session | | | |

TABLE 15
Which Sample Do You Prefer?

| | S-0 | S-25 | S-50 | No Preference |
|---|---|---|---|---|
| Day 1 | 25.6% | 34.6% | 25.6% | 14.1% |
| Day 2 | 43.4% | 30.3% | 18.4% | 7.9% |
| Day 3 | 37.3% | 32.0% | 21.3% | 9.3% |
| Day 4 | 30.3% | 43.4% | 15.8% | 10.5% |
| Day 5 | 38.2% | 30.3% | 18.4% | 13.2% |
| Average | 35.0% | 34.1% | 19.9% | 11% |
| for | | | | |
| Session | | | | |

TABLE 16
Food-To-Oil Ratio

| S-0 | S-25 | S-50 |
|---|---|---|
| 4.48 | 4.73 | 4.92 |

The compositions of the three shortenings are similar except for the make-up of the liquid fat component—it is 100% HOLL canola oil in S-0, S-25 has a ratio of HOLL canola oil to soy salad oil of 3:1, and S-50 has a ratio of HOLL canola oil to soy salad oil of 1:1. However, the S-25 sample had a food-to-oil ratio that was over 5% higher than that for the S-0 oil and the S-50 oil showed a remarkable 9.6% improvement over the S-0 sample. The S-0 and S-25 samples were comparable in overall sensory evaluation, with each being preferred by about 34-35% of the panelists on average. The sensory results for the S-50 sample, though acceptable for many applications, were not as good as those of the S-0 and S-25 samples.

### Example 3

A doughnut study was conducted using three frying shortening compositions. One shortening was DDA ZGTF Doughnut Fry Shortening (DDA), a frying shortening comprising modified palm and cottonseed oils available from Dawn Distributors Advantage of Jackson, Mich.; another was ELITE VFD doughnut frying shortening (Bunge VFD), a partially hydrogenated soybean oil (5 g of trans fat per serving) sold by Bunge North America, St. Louis, Mo.; and the third was a shortening in accordance with embodiments of the invention (S-25) and comprising about 61.5 wt % CV 65 HOLL canola oil, about 20.5 wt % non-hydrogenated soybean oil (aka “soy salad oil”), and about 18 wt % STABLE FLAKE® C, a hard flake (IV of 5 max) of partially hydrogenated soybean and cottonseed oils sold by Cargill, Incorporated, Wayzata, Minn.

The shortenings had nutrition values as reported below.

TABLE 18

| | | Bunge | |
|---|---|---|---|
| 100 grams Fat | S-25 | VFD | DDA |
| Saturated Fat | 25% | 21.7% | 46.5% |
| Trans Fat | <2.0% | 31.6% | 1.7% |
| Sat + Trans | 26.9% | 53.3% | 48.2% |

The shortenings were preheated in separate deep fat fryers for about 60 minutes to a temperature of about 350° F. The doughnuts were cooked by dropping a dozen raw doughnuts in the fryer at a time, cooking on the underside for about 45 seconds, then flipped to cook the other side for another 45 seconds. The fried doughnuts were then removed from the fryer, allowed to drain, placed on a screen, and powdered or glazed as appropriate. Each day, a make-up quantity of oil was added to each fryer as necessary to maintain comparable oil volume in the fryer.

20 dozen fresh trans free doughnuts were fried in each oil each day. The doughnuts were fried and held in controlled humidity and temperature cabinets for up to 8 hours. Sensory data was collected at 1-2, 4-5, and 7-8 hours post-fry to test consumer opinion of the 3 different doughnuts. 50-60 panelist per post-fry time were asked to give ratings of appearance, color, moisture, taste, texture, overall liking, and preference of doughnuts in each oil on each day. The overall liking data is presented below.

TABLE 19
Fresh Glazed Yeast Doughnut
Overall Liking Results

| | Day 3 | | | Day 5 | | | Day 7 | | |
|---|---|---|---|---|---|---|---|---|---|
| | S-25 | Bunge VFD | DDA | S-25 | Bunge VFD | DDA | S-25 | Bunge VFD | DDA |
| Post | 4.88 | 5.21 | 4.78 | 5.06 | 5.27 | 5.04 | 5.00 | *5.42 | 4.60 |
| Fry | | | | | | | | | |
| 1-2 | | | | | | | | | |
| Post | 5.32 | 5.26 | 4.81 | 4.94 | 4.88 | 4.60 | 5.02 | 4.75 | 5.22 |
| Fry | | | | | | | | | |
| 4-5 | | | | | | | | | |
| Post | 5.06 | 5.24 | 5.02 | 5.04 | 5.46 | 5.08 | 5.11 | 5.26 | 5.19 |
| Fry | | | | | | | | | |
| 7-8 | | | | | | | | | |
| Ave | 5.09 | 5.29 | 4.87 | 5.01 | 5.20 | 4.91 | 5.04 | 5.14 | 5.00 |

Scale: 1 = Dislike Very Much; 2 = Dislike Moderately; 3 = Dislike Slightly; 4 = Neither Dislike or Like; 5 = Like Slightly; 6 = Like Moderately; 7 = Like Very Much
*indicates a sample that is statistically different from other at post-fry time.

TABLE 20
Fresh Iced Yeast Doughnut
Overall Liking Results

| | Day 4 | | | Day 6 | | | Day 8 | | |
|---|---|---|---|---|---|---|---|---|---|
| | S-25 | Bunge VFD | DDA | S-25 | Bunge VFD | DDA | S-25 | Bunge VFD | DDA |
| Post | 4.92 | 5.25 | 5.37 | 4.91 | 5.16 | 5.05 | 4.87 | 5.31 | 5.09 |
| Fry | | | | | | | | | |
| 1-2 | | | | | | | | | |
| Post | 5.10 | 4.86 | 5.16 | 4.44 | 4.84 | 4.98 | *5.04 | 4.33 | 4.25 |
| Fry | | | | | | | | | |
| 4-5 | | | | | | | | | |
| Post | 4.81 | 4.96 | 5.09 | 4.46 | 4.86 | 4.72 | 4.72 | 4.74 | 4.94 |
| Fry | | | | | | | | | |
| 7-8 | | | | | | | | | |
| Ave | 4.94 | 5.02 | 5.21 | 4.60 | 4.95 | 4.92 | 4.88 | 4.79 | 4.76 |

Scale: 1 = Dislike Very Much; 2 = Dislike Moderately; 3 = Dislike Slightly; 4 = Neither Dislike or Like; 5 = Like Slightly; 6 = Like Moderately; 7 = Like Very Much
*indicates a sample that is statistically different from other at post-fry time.

TABLE 21
Fresh Plain Cake Doughnut
Overall Liking Results

| | Day 1 | | | Day 3 | | | Day 5 | | |
|---|---|---|---|---|---|---|---|---|---|
| | S-25 | Bunge VFD | DDA | S-25 | Bunge VFD | DDA | S-25 | Bunge VFD | DDA |
| Post | 4.50 | 4.85 | 4.77 | 4.75 | 5.22 | 4.71 | 5.29 | 5.25 | 5.06 |
| Fry | | | | | | | | | |
| 1-2 | | | | | | | | | |
| Post | 4.90 | 5.13 | 4.98 | 4.47 | 4.82 | 4.79 | 4.67 | 4.85 | 4.85 |
| Fry | | | | | | | | | |
| 4-5 | | | | | | | | | |
| Post | 4.88 | 5.00 | 4.98 | 4.46 | 4.84 | 4.80 | 4.52 | 4.62 | 4.68 |
| Fry | | | | | | | | | |
| 7-8 | | | | | | | | | |
| Ave | 4.76 | 4.99 | 4.91 | 4.56 | 4.96 | 4.77 | 4.83 | 4.91 | 4.86 |

Scale: 1 = Dislike Very Much; 2 = Dislike Moderately; 3 = Dislike Slightly; 4 = Neither Dislike or Like; 5 = Like Slightly; 6 = Like Moderately; 7 = Like Very Much
No samples statistically different from others at post-fry time.

TABLE 22
Fresh Powdered Cake Doughnut
Overall Liking Results

| | Day 2 | | | Day 4 | | | Day 6 | | |
|---|---|---|---|---|---|---|---|---|---|
| | S-25 | Bunge VFD | DDA | S-25 | Bunge VFD | DDA | S-25 | Bunge VFD | DDA |
| Post | 5.16 | 5.25 | 5.45 | 5.31 | 5.00 | 5.31 | 4.90 | 5.12 | 5.00 |
| Fry | | | | | | | | | |
| 1-2 | | | | | | | | | |
| Post | *4.73 | 5.51 | 5.49 | 4.87 | 5.09 | 5.30 | 4.64 | 4.98 | 4.54 |
| Fry | | | | | | | | | |
| 4-5 | | | | | | | | | |
| Post | 5.02 | 5.24 | 5.00 | *4.38 | 5.04 | 4.94 | 5.06 | 5.02 | 5.37 |
| Fry | | | | | | | | | |
| 7-8 | | | | | | | | | |
| Ave | 4.97 | 5.33 | 5.31 | 4.85 | 5.04 | 5.18 | 4.87 | 5.04 | 4.97 |

Scale: 1 = Dislike Very Much; 2 = Dislike Moderately; 3 = Dislike Slightly; 4 = Neither Dislike or Like; 5 = Like Slightly; 6 = Like Moderately; 7 = Like Very Much
*indicates a sample that is statistically different from other at post-fry time.

Nutritional values were determined for fresh yeast doughnuts.

TABLE 23
Fresh Yeast Doughnut Nutrition

| Nutrition | | | |
|---|---|---|---|
| (100 g | | Bunge | |
| Doughnut) | S-25 | VFD | DDA |
| Fats | 16.8 | 18.8 | 19.0 |
| Sat | 4.1 | 4.0 | 8.5 |
| MUFA | 6.1 | 5.3 | 5.3 |
| PUFA | 5.7 | 3.1 | 4.0 |
| Trans | 0.4 | 5.7 | 0.4 |
| Sat + Trans | 4.4 | 9.7 | 8.9 |

The test results indicated that S-25 delivered parity in overall liking scores to hydro and palm shortenings. The yeast doughnuts fried in S-25 contained 52% and 57% less total sat+trans than doughnuts fried in hydro and palm, respectively.

### Example 4

A doughnut study was conducted using three frying shortening compositions. One shortening was DDA ZGTF Doughnut Fry Shortening (DDA), a frying shortening comprising modified palm and cottonseed oils available from Dawn Distributors Advantage of Jackson, Mich.; another was ELITE VFD doughnut frying shortening (Bunge VFD), a partially hydrogenated soybean oil (5 g of trans fat per serving) sold by Bunge North America, St. Louis, Mo.; and the third was a shortening in accordance with embodiments of the invention (S-25) and comprising about 61.5 wt % CV 65 HOLL canola oil, about 20.5 wt % non-hydrogenated soybean oil (aka “soy salad oil”), and about 18 wt % STABLE FLAKE® C, a hard flake (IV of 5 max) of partially hydrogenated soybean and cottonseed oils sold by Cargill, Incorporated, Wayzata, Minn.

The shortenings were preheated in separate deep fat fryers for about 60 minutes to a temperature of about 350° F. The doughnuts were cooked by dropping a dozen raw doughnuts in the fryer at a time, cooking on the underside for about 45 seconds, then flipped to cook the other side for another 45 seconds. The fried doughnuts were then removed from the fryer, allowed to drain, placed on a screen, and were powdered, glazed, or iced, as appropriate. Each day, a make-up quantity of oil was added to each fryer as necessary to maintain comparable oil volume in the fryer.

For each type of doughnut, 10 dozen fresh trans free doughnuts were fried in each oil at 360° F. 5 doughnuts from each oil were immediately iced and tested for sensory characteristics. 5 dozen doughnuts were fried, cooled, and packaged in air-tight sealed plastic packaging and were frozen for 10 days at 0° F. On day 10, the doughnuts were thawed, warmed to 120° F., iced, and tested for sensory characteristics. Sensory data was collected to test consumer opinion of the 3 different doughnuts. 50-60 panelist per post-fry time were asked to give ratings of appearance, color, moisture, taste, texture, overall liking, and preference of doughnuts in each oil on each day. The overall liking data is presented below. Statistical differences were calculated based on the shortenings per day.

TABLE 25
Chocolate Iced Doughnuts

| | S-25 | Bunge VFD | DDA |
|---|---|---|---|
| | Color | | |
| Day 1 | 3.70 | *4.32 | *4.08 |
| Day 10 | 4.17 | *4.49 | 4.19 |
| | Texture | | |
| Day 1 | 4.66 | *5.18 | *5.18 |
| Day 10 | 4.91 | 4.49 | 4.79 |
| | Appearance | | |
| Day 1 | 5.06 | 4.70 | *5.58 |
| Day 10 | 5.42 | 5.77 | *5.83 (higher than |
| | | | S-25, but not VFD) |
| | Moisture Content | | |
| Day 1 | 3.76 | 3.70 | 3.90 |
| Day 10 | 3.64 | 3.53 | 3.77 |
| | Taste | | |
| Day 1 | 5.08 | *5.56 | *5.72 |
| Day 10 | 5.45 | 5.28 | 5.34 |
| | Overall Liking | | |
| Day 1 | 4.98 | 5.40 | *5.64 |
| Day 10 | 5.19 | 5.11 | 5.21 |
| | Which Sample Do You Prefer? | | |
| Day 1 | 16 (30.8%) | 14 (26.9%) | 17 (32.7%) |
| Day 10 | 17 (32.1%) | 12 (22.6%) | 18 (34%) |

| | All Samples Preferred Equally |
|---|---|
| Day 1 | 5 (9.6%) |
| Day 10 | 6 (11.3%) |

*Indicates that the shortening was rated statistically significantly higher for the attribute for this day.

TABLE 26
Glazed Doughnuts

| | | Bunge | |
|---|---|---|---|
| | S-25 | VFD | DDA |
| | Color | | |
| Day 1 | 3.76 | 4.38 | 4.70 |
| Day 10 | 4.06 | 4.50 | 4.50 |
| | Texture | | |
| Day 1 | 4.74 | 4.94 | 4.80 |
| Day 10 | 4.28 | 4.68 | 4.50 |
| | Appearance | | |
| Day 1 | 5.68 | 5.06 | 4.74 |
| Day 10 | 5.38 | 5.30 | 4.98 |
| | Moisture Content | | |
| Day 1 | 4.06 | 3.80 | 3.48 |
| Day 10 | 3.88 | 3.94 | 3.80 |
| | Taste | | |
| Day 1 | 5.38 | 5.54 | 5.34 |
| Day 10 | 5.02 | 5.40 | 5.12 |
| | Overall Liking | | |
| Day 1 | 5.14 | 5.20 | 5.02 |
| Day 10 | 5.08 | 5.32 | 4.88 |
| | Which Sample Do You Prefer? | | |
| Day 1 | 19 (38%) | 16 (32%) | 14 (28%) |
| Day 10 | 17 (34%) | 18 (36%) | 12 (24%) |

| | All Samples Preferred Equally |
|---|---|
| Day 1 | 1 (2%) |
| Day 10 | 3 (6%) |

*Indicates that the shortening was rated statistically significantly higher for the attribute for this day.

The test results indicated that S-25 delivered parity in overall liking scores to hydro and palm shortenings.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The above-detailed embodiments and examples are intended to be illustrative, not exhaustive, and those skilled in the art will recognize that various equivalent modifications are possible within the scope of the invention. For example, whereas steps are presented in a given order, alternative embodiments may perform steps in a different order. The various embodiments described herein can be combined to provide further embodiments.

In general, the terms used in the following claims should not be construed to limit the invention to the specific embodiments disclosed in the specification unless the preceding description explicitly defines such terms. The inventors reserve the right to add additional claims after filing the application to pursue additional claim forms for other aspects of the invention.

1. A frying shortening composition comprising: (a) about 70-99 wt % of a liquid oil component comprising: (i) a first liquid oil comprising canola oil; and (ii) a second liquid oil comprising soybean oil; and (b) about 1-30 wt % of a hard fat component comprising a hydrogenated cottonseed oil.

2. The frying shortening composition of claim 1, wherein the composition comprises about 80-84 wt % of the liquid oil component; and about 16-20 wt % of the hard fat component.

3. (canceled)

4. The frying shortening composition of claim 1, wherein the first liquid oil comprises high oleic, low linolenic (HOLL) canola oil.

5. The frying shortening composition of claim 1, wherein the second liquid oil comprises conventional soy salad oil; low-linolenic soybean oil; mid-oleic, low-linolenic soybean oil; or combinations thereof.

6. The frying shortening composition of claim 1, wherein the liquid oil component comprises less than about 2 wt % trans-fatty acids.

7. (canceled)

8. The frying shortening composition of claim 1, wherein the liquid oil component comprises between about 7 wt % and about 56 wt % polyunsaturated fatty acids.

9. The frying shortening composition of claim 1, wherein the liquid oil component comprises less than about 15 wt % saturated fatty acids.

10. The frying shortening composition of claim 1, wherein the shortening composition comprises about 40-63 wt % canola oil; about 20-42 wt % soybean oil; and about 16-20 wt % hydrogenated cottonseed oil.

11-12. (canceled)

13. The frying shortening composition of claim 1, wherein the canola oil and soybean oil are present in a weight ratio of canola oil to soybean oil (wt canola:wt soybean) ranging from about 40:1 to about 1:1.

14. The frying shortening composition of claim 1, wherein the canola oil and soybean oil are present in a weight ratio of canola oil to soybean oil (wt canola:wt soybean) ranging from about 1:1 to about 3:1.

15. The frying shortening composition of claim 1, wherein a 14 gram serving of the frying shortening composition has no more than 0.5 grams of trans-fatty acids.

16. The frying shortening composition of claim 1, wherein the frying shortening comprises about 30 wt % saturated fat or less.

17-18. (canceled)

19. A frying shortening composition comprising:
(a) about 70-99 wt % of a liquid oil component comprising:
(i) a first liquid oil comprising canola oil; and
(ii) a second liquid oil comprising at least one oil selected from the group consisting of soybean oil, mid-oleic sunflower oil, corn oil, and combinations thereof; and
(b) about 1-30 wt % of a hard fat component comprising a hydrogenated vegetable oil.

20-21. (canceled)

22. A frying shortening composition comprising:
(a) about 70-99 wt % of a liquid oil component comprising:
(i) a first liquid oil comprising HOLL canola oil; and
(ii) a second liquid oil selected from the group consisting of soybean oil, canola oil, sunflower oil, corn oil, and combinations thereof; and
(b) about 1-30 wt % of a hard fat component comprising hydrogenated cottonseed oil.

23. The frying shortening composition of claim 22, wherein the liquid oil component comprises (i) a first liquid oil comprising HOLL canola oil; and (ii) a second liquid oil comprising conventional canola oil; wherein the HOLL canola oil and the conventional canola oil are present in a ratio of about 40:1 to about 1:1.

24. A method of making a fried food article comprising:
(a) providing a frying shortening composition according to any one of claims 1-23; and
(b) frying a food article in the shortening composition to form the fried food article.

25. A fried food article prepared by the process of claim 24.

26. (canceled)

27. The fried food article of claim 25, wherein the food article contains about 0.5 grams of trans-fatty acids per serving or less.

28. The fried food article of claim 25, wherein the fried food article has a food-to-oil ratio that is at least about 5% higher than a fried food article prepared with a shortening composition comprising 83 wt % HOLL canola oil and 17 wt % hydrogenated cottonseed oil.

29. The fried food article of claim 25, wherein the fried food article has a food-to-oil ratio is at least about 5% higher than a fried food article prepared with a shortening composition comprising modified palm and cottonseed oil.

30. (canceled)
